(19) United States
(12) Patent Application Publication
(10) Pub. No.: US 2004/0060647 A1
(43) Pub. Date: Apr. 1, 2004

(54) Method and apparatus for creating micro-cut plate break

(76) Inventor: Burt Tabora, Franklin, WI (US)

Correspondence Address: JOSEPH S. HEINO, ESQ., DAVIS & KUELTHAU, S.C., 111 E. KILBOURN, SUITE 1400, MILWAUKEE, WI, 53202-6613, US

(21) Appl. No.: 10/255,521

(22) Filed: Sep. 26, 2002

(51) Int. Cl. B32B 31/00

(52) U.S. Cl. 156/258; 156/450; 156/512

(57) ABSTRACT

A method and apparatus utilizes a flexographic printing cylinder or print sleeve that is functionally adapted to have a photopolymeric printing plate removably attached to it. A micro-cutting mechanism is also provided that is axially aligned with the printing cylinder or print sleeve whereby a cutting tool, such as a knife, blade, straight edge or laser, can be drawn across the printing cylinder or print sleeve to cut a portion of the printing plate that is mounted thereto. In the method and apparatus of the present invention, and after the printing plate is attached at a point along the cylinder or sleeve, the micro-cutting mechanism is placed proximally to the printing cylinder or sleeve and the cutting tool is drawn along a line and across a portion of the printing plate. This forms a first cut through the plate. The cut may be at an angle relative to the perpendicular of the cylinder or sleeve, or the cut may be perpendicular to the surface of the cylinder or sleeve. The cylinder or sleeve is then advanced precisely to the point that a second cut can be made through the plate. In this fashion, the first and second cuts result in plate ends that align such that the break in the plate is minimized.

### FIELD OF THE INVENTION

This invention relates generally to the field of flexographic printing and to photopolymerizable printing plates used in flexographic printing. More specifically, it relates to a method and apparatus for micro-cutting the edges of such photopolymerizable printing plates to create an essentially seamless joint or break between the leading edge and the trailing edge of a printing plate that is mounted to a printing cylinder.

The use of photopolymerizable printing plates is well known in the art of flexographic printing. Flexographic printing plates are particularly useful for printing images and text on surfaces and materials that are soft, flexible and easily deformable. Such flexible surfaces and materials, especially packaging materials of paper, plastic films or metal foils, or materials with an irregular surface, are in practice printed primarily by the flexographic printing process.

Printing plates that have the qualities of high elasticity and flexibility are obviously needed for this flexographic printing process, caused especially by the nature of the aforementioned materials that are to be printed on. Flexographic printing plates must fulfill a large number of requirements, caused especially by these materials that are to be printed on. On the one hand, they must be soft enough to fit the irregular surface of the materials to be printed on, but on the other hand they must be resistant to abrasion and must have a certain strength. A high tensile strength is required, combined with rapid ability to recover, as well as resistance to the solvents of the printing ink.

Photopolymerized printing plates for flexographic printing consist of a light-sensitive layer usually applied onto a layer support. The essential elements of the photosensitive layer include a light-hardenable compound, an elastomeric binder, and a photoinitiator. To produce the flexographic printing plate, the photopolymerizable layer is exposed through an original film that is selectively opaque and transparent depending upon the text or design that is desired or required. To produce an optimum printing surface, the flexographic printing plate is then chemically treated and subsequently exposed to actinic radiation. Upon exposure to actinic radiation, polymerization and the resulting insolubilization of the photopolymerizable layer occurs in the exposed areas. Treatment with a suitable solvent removes the unexposed areas of the photopolymerizable layer thereby leaving a printing relief that can be used for flexographic printing. These treatment steps can optionally be carried with the plate mounted on a printing cylinder.

For purposes of printing, the flexographic printing plate or, if the printing plate is produced on a printing cylinder, the photopolymerizable printing element is mounted on the printing cylinder or print sleeve or on an endless belt. In practice, printing plates are frequently composed of individual parts or a single printing plate that is laid around a printing roll and the ends are urged together. That is, flexographic printing plates are made from a flat substrate that is distorted to form a rounded surface to be mounted on round plate cylinders or print sleeve for cyclical and repetitive printing. Regardless of how tight the joint is between the two ends of the plate, a seam is always present. The ends are typically fixed to the cylinder or print sleeve by taping them to the cylinder or print sleeve, using double-sided adhesive tape. If printing plates consisting of individual parts are used, the edges of the individual parts likewise abut at the respective connection points and are similarly fixed on the printing cylinder or print sleeve with double-sided adhesive tapes.

### BACKGROUND OF THE INVENTION

Processes to connect the edges of photopolymerizable printing elements have been attempted previously. The formation of so-called “seamless” printing elements can, in the experience of this inventor, be accomplished by several methods. For example, one such method utilizes a combined pressure and heat treatment that requires a great deal of equipment. Unfortunately, this process also usually requires a subsequent smoothing process, as well as further post-treatment steps.

Other attempts have been made to seal the gap between abutting edges by inserting filling materials such as adhesive cement or filling compositions based on rubber, polyacrylate or epoxy resins and the like. In this manner, however, non-printing connection points are obtained whose strength and elastic properties are not adequate to withstand the forces acting on the photopolymer printing plate during printing and the repeated manual mounting and unmounting so that the connection points break open again after relatively short periods of operation.

Photosensitive resin layers can also be made from a layer of photopolymeric composition by a SEAMEX® process. The SEAMEX® process involves wrapping a layer of photopolymeric material to a nickel sleeve, also known as a print sleeve, having a heat-activated primer coat to bond with the material so that the ends of the plate are joined together. The entire assembly is placed in an oven to cure and bond the photopolymeric layer to the primer coat and melt the ends of the photopolymeric layer together. The photopolymeric layer on the sleeve is then ground to the necessary thickness, wiped clean and sprayed with a protective coating to prevent negatives from sticking to the photopolymer during exposure. This process of wrapping, curing and melting, grinding and spraying the photopolymeric layer to the sleeve takes up to two days to accomplish. The cylindrical photopolymeric layer on the sleeve then undergoes the same steps of exposure to photopolymerize those areas of the layer exposed to light and the process of washing away the unpolymerized areas of the layer on the cylinder, thereby forming a relief surface for printing. Obviously, this method is not only time consuming, but relatively expensive.

### SUMMARY OF THE INVENTION

It is therefore an object of the present invention to provide a new and useful method and apparatus that is suitable for joining the edges of photopolymerizable printing plates whereby a micro-cut plate break is created at the leading and trailing edges of the printing plate. It is another object of the present invention to provide such a method and apparatus whereby the micro-cut edges of the printing plate, when joined together in usual fashion, create a virtually seamless plate break. It is still another object of the present invention to provide such a method and apparatus whereby a micro-cutting device is utilized to cut the edges of the printing plate while the plate is mounted in whole or in part to a flexographic printing cylinder or to a print sleeve. It is yet another object of the present invention to provide such a method and apparatus whereby the micro-cutting may be accomplished linearly along the longitudinal axis of a printing cylinder or transversely across the longitudinal axis of the printing cylinder, or in any combination thereof, as such is desired-or required. It is a further object of the method and apparatus of the present invention to fabricate and assemble such a device which will accomplish all of the foregoing without great expense, which will allow flexographic printers to readily and easily use the device, and which utilizes a minimum number of elements to assemble and a minimum number of steps to operate.

The method and apparatus of the present invention has obtained these objects. It provides for a printing cylinder, or a print sleeve, that is functionally adapted to have a photopolymer printing plate removably attached to it. It also provides for a micro-cutting mechanism that is axially aligned with the printing cylinder or print sleeve whereby a cutting tool, such as a knife, blade, straight edge or laser, can be drawn across the printing cylinder or print sleeve to cut a portion of the printing plate that is mounted to the cylinder or print sleeve. In the method and apparatus of the present invention, and after the printing plate is attached at a point along the cylinder or print sleeve, the micro-cutting mechanism is placed proximally to the printing cylinder or print sleeve and the cutting tool is drawn along a line and across a portion of the printing plate. This forms a first cut through the plate. The cut may be at an angle relative to the perpendicular of the cylinder or print sleeve, or the cut may be perpendicular to the surface of the cylinder or print sleeve. The cylinder or print sleeve is then advanced precisely to the point that a second cut can be made through the plate. In this fashion, the first and second cuts result in plate ends that align such that the break in the plate is minimized. The foregoing and other features of the method and apparatus of the present invention will be apparent from the detailed description that follows.

### BRIEF DESCRIPTION OF THE DRAWINGS

FIG. 1 is a top, front and right side perspective view of an apparatus constructed in accordance with the present invention and showing a printing cylinder or print sleeve movably mounted in proximity to a micro-cutting mechanism.

FIG. 2A is a front and left side perspective view of the printing cylinder or print sleeve shown in FIG. 1 and showing a leading edge of the printing plate attached to the cylinder or print sleeve and a micro-cut line.

FIG. 2B is another front and left side perspective view of the printing cylinder or print sleeve shown in FIG. 2A and showing the leading edge of the printing plate after it has been micro-cut in accordance with the present invention.

FIG. 2C is another front and left side perspective view of the printing cylinder or print sleeve shown in FIG. 2B and showing the trailing edge of the printing plate overlapping the longitudinal micro-cut line illustrated in FIG. 2A.

FIG. 2D is another front and left side perspective view of the trailing edge of the printing plate after the trailing edge has been micro-cut in accordance with the present invention.

FIG. 2E is another front and left side perspective view of the printing plate after the micro-cut leading and trailing edges have been joined together.

FIG. 3A is a left side elevational view of the printing cylinder or print sleeve shown in FIG. 2A and showing a leading edge of the printing plate attached to the cylinder or print sleeve and a micro-cut line.

FIG. 3B is another left side elevational view of the printing cylinder or print sleeve shown in FIG. 2B and showing the leading edge of the printing plate after it has been micro-cut in accordance with the present invention.

FIG. 3C is another left side elevational view of the printing cylinder or print sleeve shown in FIG. 2C and showing the trailing edge of the printing plate overlapping the longitudinal micro-cut line illustrated in FIG. 3A.

FIG. 3D is another left side elevational view of the trailing edge of the printing plate after the trailing edge has been micro-cut in accordance with the present invention.

FIG. 3E is another left side elevational view of the printing plate after the micro-cut leading and trailing edges have been joined together.

FIG. 4 is an enlarged partial left side elevational view of the printing cylinder or print sleeve and plate illustrated in FIG. 3E and showing the micro-cut line.

FIG. 5 is a front elevational view of the printing cylinder or print sleeve illustrated in FIG. 1 and showing a disjointed, but continuous, cut line made in the printing plate.

FIG. 6 is a front elevational view of the printing cylinder or print sleeve illustrated in FIG. 1 and showing an undulated cut line made in the printing plate.

### DETAILED DESCRIPTION

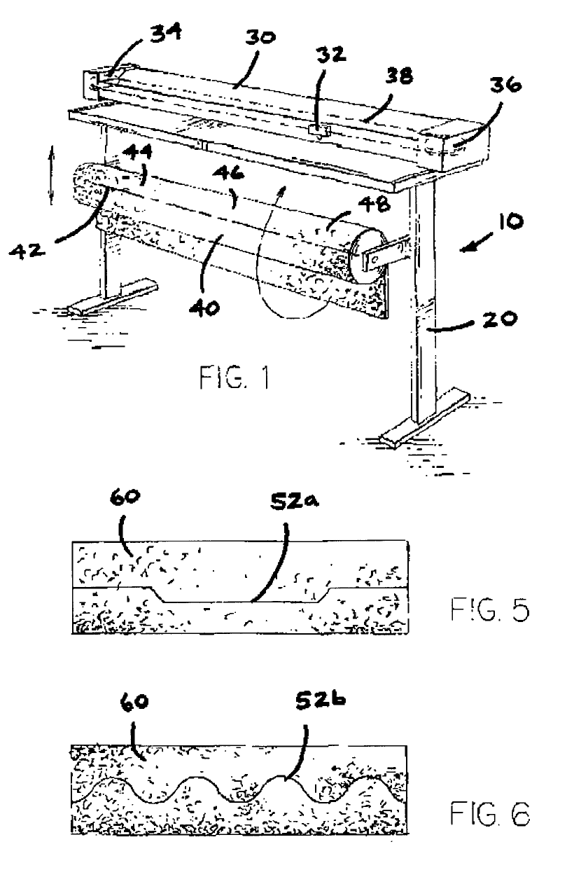

The following detailed description is intended to describe the preferred embodiment that is depicted in the figures. It is to be understood that changes could be made to that which is specifically described and shown that would still fall within the scope of the present invention. Referring now to the drawings in detail, wherein like numbered elements refer to like elements throughout, FIG. 1 illustrates the basic components of a micro-cutting device, generally identified 10, constructed in accordance with the present invention. The micro-cutting device 10 is used for cutting one or more edges of a flexographic printing plate. As shown, the micro-cutting device 10 includes a main support frame 20. A longitudinally extending flexographic printing cylinder or print sleeve 40 is rotatably attached to the support frame 20. Similarly, a longitudinally extending micro-cutting mechanism 30 is movably attached to the same support frame 20. The precise configuration of the support frame 20 is not a functional limitation of the device and method of the present invention. That is, while the simplistic embodiment shown accomplishes the intended purpose, it is to be understood that the precise placement and mounting expediency of the printing cylinder or print sleeve 40 to the support frame and the movement of the printing cylinder or print sleeve 40 relative to the support frame 20 may be varied without deviating from the scope of the present invention. Similarly, the micro-cutting mechanism's 30 mounting to and movement relative to the support frame 20 may also be varied without deviating from the scope of the present invention.

The flexographic printing cylinder or print sleeve 40 has a central axis 42 about which the cylinder or print sleeve 40 rotates, a first end 44, a second end 48 and a central outer perimeter portion 46 about which is attached a double-sided tape media 50. The purpose of this double-sided tape media 50 is to allow the removable mounting of the flexographic printing plate 60 on to the printing cylinder or print sleeve 40. Mounted immediately above the printing cylinder or print sleeve 40 shown in FIG. 1 is the micro-cutting mechanism 30 that includes a cutting blade 32, or similar structure, and a blade moving mechanism. In the embodiment described herein, the mechanism for moving the cutting blade 32 are a pair of servo drives 34, 36 and a continuous belt 38 contained within the cutting mechanism 30 which allow the cutting blade 32 to move longitudinally back and forth along the length of the mechanism 30. It is to be understood that the cutting mechanism 30 could also incorporate a track, a worm gear, or any other design expediency that would facilitate movement of the cutting blade 32 in at least two linear directions, the same not being a limitation of the present invention. When proximally engaged with the flexographic printing cylinder or print sleeve 40, the micro-cutting mechanism 30 allows the cutting blade 32 to engage and actually cut through a portion of the flexographic printing plate 60 that is mounted to the printing cylinder or print sleeve 40.

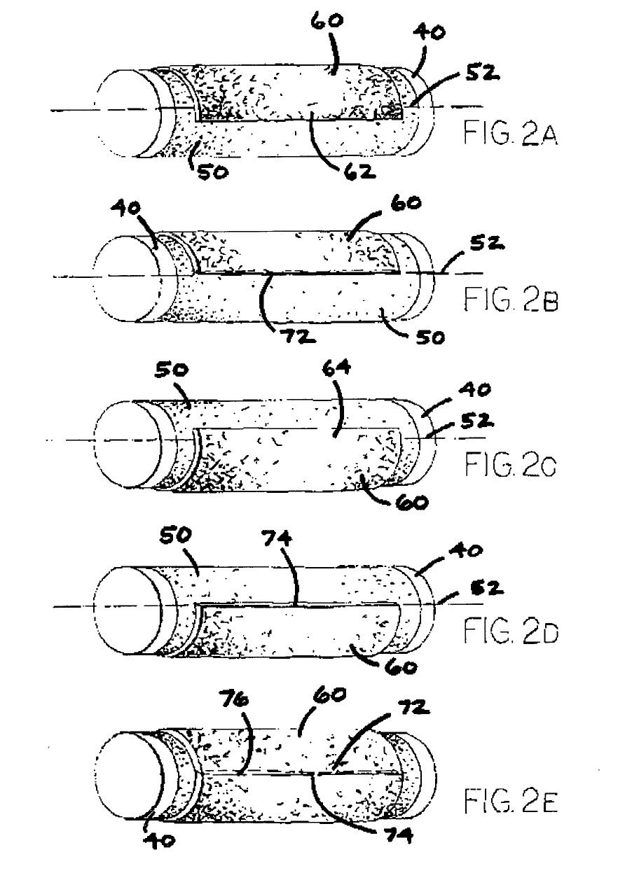

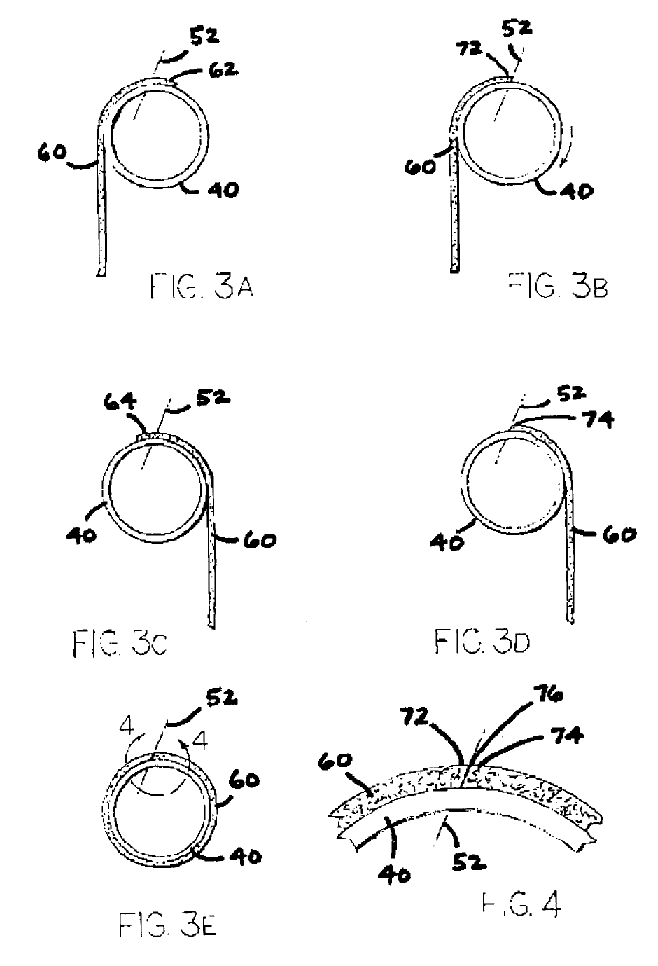

Referring now to FIGS. 2A through 2E, it will be shown that a portion of a flexographic printing plate 60 is removably attached to the double-sided media 50 that is mounted to the central outer perimeter 46 of the printing cylinder or print sleeve 40. More specifically, the leading edge 62 of the flexographic printing plate 60 overlies a longitudinal line defined along the printing cylinder or print sleeve 40 that is substantially parallel to the axis 42 of the cylinder or print sleeve 40. See FIG. 2A. This longitudinal line also defines a “cut line” 52 which is significant not only with respect to this leading edge 62 but also to the trailing edge 64 of the printing plate 60. See also FIG. 3A. This will become more apparent and will be explained further later in this detailed description.

As the leading edge 62 of the printing plate 60 overlies this portion of the printing cylinder or print sleeve 40 at the point of the cut line 52, the printing cylinder or print sleeve 40 is either moved upwardly or the micro-cutting mechanism 30 is moved downwardly, mechanically or otherwise, to bring the micro-cutting mechanism 30 into a position that is immediately adjacent the printing cylinder or print sleeve 40. The micro-cutting mechanism 30 is then engaged and the cutting blade 32 is drawn in one direction 54 along the cut line 52 and across the leading edge 62 of the printing plate 60. This allows a portion of the printing plate 60 to be excised from the remaining portion of the printing plate 60. See FIG. 2B. Most importantly, a precise cut is made along that leading edge 62 and a newly leading edge 72 is formed. See also FIG. 3B. As shown, the cutting blade 32 presents at an angle relative to the printing cylinder or print sleeve 40 and the newly formed leading edge 72 is formed at that same angle. The precise angle of cut is not, however, a limitation of this invention.

The micro-cutting mechanism 30 and the printing cylinder or print sleeve 40 are then backed away from one another. The newly formed leading edge 72 is then gently urged away from the printing cylinder or print sleeve 40 as the trailing edge 64 of the flexographic printing plate 60 is similarly positioned by precise advancement of the cylinder or print sleeve 40 such that a portion of the trailing edge 64 of the printing plate 60 overlies the cut line 52 previously defined and described. See FIGS. 2C and 3C.

During this process, the micro-cutting mechanism 30 returns the cutting blade 32 to its original position. That is, the position that the cutting blade 32 had prior to the first cut being made. Alternatively, the micro-cutting mechanism 30 may be engaged such that the cutting blade 32 is drawn in the reverse direction 56 along the longitudinal cut line 52. Such is not a functional limitation of the present invention. An electronic control means (not shown) may be utilized to move and drive the cutting mechanism 30 in accordance with a preprogrammed scheme as such is desired or required. Such control means could be in the form of any commercially available programmable microprocessor with electronic connections to the drive mechanisms previously described for moving the cutting mechanism 30 and the blade 32 into proximity to the cylinder or print sleeve 40, for precisely positioning the cylinder or print sleeve 40 in relation to the cutting blade 32 and for moving the blade 32 along the cylinder or print sleeve 40 in accordance with a pre-programmed scheme determined by the user. Either way, a portion of the trailing edge 64 is similarly cut away from the major portion of the printing plate 60. See FIG. 2D. A newly cut trailing edge 74 is created thereby. As shown, the newly formed trailing edge 74 is formed at the same angle as that of the newly formed leading edge 72. See FIG. 3D. In this fashion, the edges 72, 74 now cut at the leading edge and the trailing edge of the printing plate 60 are movable towards the cut line 52 and, when placed in close proximity to one another, create a micro-cut plate break 76 between those edges 72, 74. See FIGS. 2E and 3E. This results in a virtually seamless flexographic printing plate 60 that is now fully mounted to the printing cylinder or print sleeve 40 without the need for any type of filler being added to the break or seam 76. See FIG. 4.

In an alternative embodiment, the flexographic printing plate 60 may be cut not only in the longitudinal direction, but also somewhat transversely. See, for example, FIG. 5. This accommodates a variety of printing formats and designs that may be desired or required in the end product of the printed media. Such a result is accomplished by a combination of longitudinal movement and transverse movement of the cutting blade 32 relative to the printing cylinder or print sleeve 40, which movement may be accomplished by manual means or by providing an electronic control means (not shown) as previously decribed and moving the blade 32 and cylinder or print sleeve 40 in accordance with the electronically controlled and preprogrammed scheme in order to achieve identical cuts along this disjointed cut line 52a. A relatively smooth and continuous cut line 52b may also be effected in a less disjointed fashion, also by incremental and precise relative movement between the cylinder or print sleeve 40 and the cutting blade 32 in accordance with the preprogrammed scheme desired or required by the user. See FIG. 6. In this latter fashion, certain critical portions of the end product, i.e. the printed media, are strategically negotiated around and left unaffected by the resulting cut line 52b.

Accordingly, it will be seen from the foregoing that there has been provided a new and useful method and apparatus that is suitable for joining the edges of photopolymerizable printing plates whereby a micro-cut plate break is created at the leading and trailing edges of the printing plate; whereby the micro-cut edges of the printing plate, when joined together in usual fashion, create a virtually seamless plate break; whereby a micro-cutting device is utilized to cut the edges of the printing plate while the plate is mounted in whole or in part to a flexographic printing cylinder or to a print sleeve; whereby the micro-cutting may be accomplished linearly along the longitudinal axis of a printing cylinder or print sleeve, transversely across the longitudinal axis of the printing cylinder or print sleeve, or in some nonlinear combination thereof as such is desired or required; and whereby all of the foregoing is accomplished in the fabrication and assembly of such a device without great expense, which will allow flexographic printers to readily and easily use the method and device, and which utilizes a minimum number of elements to assemble and a minimum number of steps to operate.

The principles of this invention having been fully explained in connection with the foregoing, I hereby claim as my invention:

1. A method for joining the edges of a photopolymerizable printing plate of the type used in flexographic printing that comprises the steps of
providing a photopolymerizable printing plate, said plate having a leading edge and a trailing edge,
providing a printing cylinder or print sleeve that is functionally adapted to have a printing plate removably attached to it,
providing a cutting mechanism
removably attaching the leading edge of said plate to a portion of the cylinder or print sleeve,
drawing the cutting mechanism across said leading edge,
removably attaching the trailing edge of said plate to a portion of the cylinder or print sleeve, and
drawing the cutting mechanism across the trailing edge,
whereby a micro-cut plate break is created between the leading edge and the trailing edge of the plate when it is mounted to the printing cylinder or print sleeve.

2. The method of claim 1 wherein said cutting mechanism providing step includes providing a cutting blade and means for moving the cutting blade along the printing cylinder or print sleeve.

3. The method of claim 2 wherein the micro-cut plate break is made along a cut line.

4. The method of claim 3 including, prior to the cutting mechanism cutting step, the step of moving the cutting mechanism into proximity with the cylinder or print sleeve.

5. The method of claim 4 wherein the cylinder or print sleeve providing step includes providing a cylinder or print sleeve that is rotatable about an axis and a micro-cut plate break that is made along a line that is generally parallel to said axis.

6. The method of claim 5 wherein the micro-cut plate break is made along a line that is not straight.

7. The method of claim 6 wherein the micro-cut plate break is made according to a pre-programmed scheme.

8. The method of claim 7 wherein said cutting mechanism providing step includes providing a mechanical, heat or light amplified cutting device.

9. An apparatus for joining the edges of a photopolymerizable printing plate of the type used in flexographic printing that comprises
a printing cylinder or print sleeve that is functionally adapted to have a printing plate removably attached to it, said printing plate having a leading edge and a trailing edge,
a cutting mechanism,
means for removably attaching the leading edge of said plate to a portion of the cylinder or print sleeve,
means for drawing the cutting mechanism across said leading edge,
means for removably attaching the trailing edge of said plate to a portion of the cylinder or print sleeve, and
means for drawing the cutting mechanism across the trailing edge,
whereby a micro-cut plate break is created between the leading edge and the trailing edge of the plate when it is mounted to the printing cylinder or print sleeve.

10. The edge joining device claim 9 wherein said cutting mechanism includes a cutting blade and means for moving the cutting blade along the printing cylinder or print sleeve.

11. The edge joining device of claim 10 wherein the micro-cut plate break is made along a cut line.

12. The edge joining device of claim 11 wherein the cylinder is rotatable about an axis and the micro-cut plate break is made along a line that is generally parallel to said axis or print sleeve.

13. The edge joining device of claim 12 including means for moving the cutting mechanism into proximity with the cylinder or print sleeve.

14. The edge joining device of claim 13 including means for cutting the leading edge at an angle and means for cutting the trailing edge at a complimentary angle.

15. The edge joining device of claim 14 wherein said cutting mechanism includes a mechanical, heat or light amplified cutting device.

16. The edge joining device of claim 15 wherein the micro-cut plate break is made along a line that is not straight.
